(19) United States
(12) Patent Application Publication
(10) Pub. No.: US 2010/0004767 A1
(43) Pub. Date: Jan. 7, 2010

(54) Method for Controlling Projector and Projection System using the same

(76) Inventors: Ke-Shun Tu, Hsin-Chu (TW); Po-Yen Wu, Hsin-Chu (TW); Chih-Lin Wang, Hsin-Chu (TW)

Correspondence Address: LanWay IPR Services, P.O. box 223205, Chantilly, VA, 20153, US

(21) Appl. No.: 12/484,217

(22) Filed: Jun. 14, 2009

(30) Foreign Application Priority Data
Jul. 4, 2008 (TW) 097125254

(51) Int. Cl. G06F 17/00; G05B 11/01

(52) U.S. Cl. 700/94; 700/11; 700/90

(57) ABSTRACT

In a method for controlling projector and a projection system using the same, the method is adapted to a projector. The projector receives a multimedia data from a host and through a multimedia-data transmitting interface. The projector judges whether the multimedia data includes a predetermined data in advance, and then performs an operation for controlling the projector corresponding to the predetermined data if the multimedia data includes the predetermined data.

### CROSS-REFERENCE TO RELATED APPLICATIONS

This application is based upon and claims the benefit of priority from the prior Taiwanese Patent Application No. 097125254, filed Jul. 4, 2008, the entire contents of which are incorporated herein by reference.

### BACKGROUND

1. Field of the Invention

The present invention relates to a method for controlling projector, and more particularly, to a method for controlling projector, the method for controlling projector employs a multimedia-data transmitting interface to transmit data predetermined by a projector, and a projection system using the same.

2. Description of the Related Art

In the modern life, multimedia devices have been an indispensable apparatus. A general multimedia device includes various adjusting and control mechanisms designed thereon to fit various conditions. For example, a loudspeaker generally has a knob configured for adjusting a volume thereof, and a computer screen has many buttons configured for adjusting various parameters thereof.

However, if the various control and adjusting mechanisms are arranged directly on the multimedia device, a capability for controlling or adjusting the various parameters may be limited greatly. If most of the various parameters of the multimedia device are adjustable, the multimedia device needs more buttons arranged thereon or a more complicated operation interface. Therefore, some multimedia devices are designed to be adjusted directly by hosts communicating with the multimedia devices. Referring to FIG. 1, a conventional projection system is provided. In this projection system, a host 100 transmits multimedia data, such as video, etc., to a projector 110 through a multimedia-data transmitting line 102. In addition, control signals configured for controlling the operation of the projector 110, are transmitted by another independent control line 104. The control line 104 generally employs an interface, such as a universal serial bus (USB) or a recommended standard 232 (RS232), etc., as the communicating standard for transmitting data.

However, the conventional projection system needs an additional connecting interface to transmit the control signals, thus the whole manufacturing cost thereof is increased and the assembly thereof is more complicated.

Providing a method for controlling projector is indispensable, and may solve the above problems.

### BRIEF SUMMARY

In order to achieve one or part of or all the objectives or other objectives, a method for controlling projector in accordance with an exemplary embodiment of the present invention is provided. The method for controlling projector is adapted to a projector, and the projector receives a multimedia data from a host and through a multimedia-data transmitting interface. The method for controlling projector includes: judging whether the multimedia data includes a predetermined data; and performing an operation for controlling the projector corresponding to the predetermined data if the multimedia data includes the predetermined data.

A method for controlling projector in accordance with another exemplary embodiment of the present invention is provided. The method for controlling projector includes: defining a multimedia data having a predetermined data in a host; and transmitting the multimedia data to a projector through a multimedia-data transmitting interface to control the projector.

A projection system in accordance with other exemplary embodiment of the present invention is provided. The projection system includes a host and a projector. The host includes a multimedia-data generating unit configured for providing a multimedia data, and a multimedia-data sending unit electrically connected to the multimedia-data generating unit and configured for receiving the multimedia data and transmitting the multimedia data out of the host. The projector includes a multimedia-data receiving unit, a multimedia-data decoder, and a processor. The multimedia-data receiving unit is electrically connected to the multimedia-data sending unit of the host and is configured for receiving the multimedia data from the multimedia-data sending unit of the host. The multimedia-data decoder is electrically connected to the multimedia-data receiving unit and is configured for decoding the multimedia data received from the multimedia-data receiving unit to obtain a corresponding decoded result. The processor is configured for adjusting or controlling the projector according to the predetermined data, if the decoded result represents that the multimedia data includes the predetermined data.

The exemplary embodiment of the present invention employs the multimedia data including the predetermined data as the control signal, such that the exemplary embodiment does not need the independent control-signal line and may effectively control the exterior projector. Furthermore, the manufacturing cost thereof is decreased and the operation thereof is simpler.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a conventional projection system.

FIG. 2 is a block diagram of a projection system in accordance with an exemplary embodiment of the present invention.

FIG. 3 is a flow chart of a method for controlling projector, and the method for controlling projector is performed on a host in accordance with an exemplary embodiment of the present invention.

FIG. 4 is a flow chart of a method for controlling projector, and the method for controlling projector is performed on a projector in accordance with an exemplary embodiment of the present invention.

FIG. 5 is a circuit block diagram of a projection system in accordance with an exemplary embodiment of the present invention.

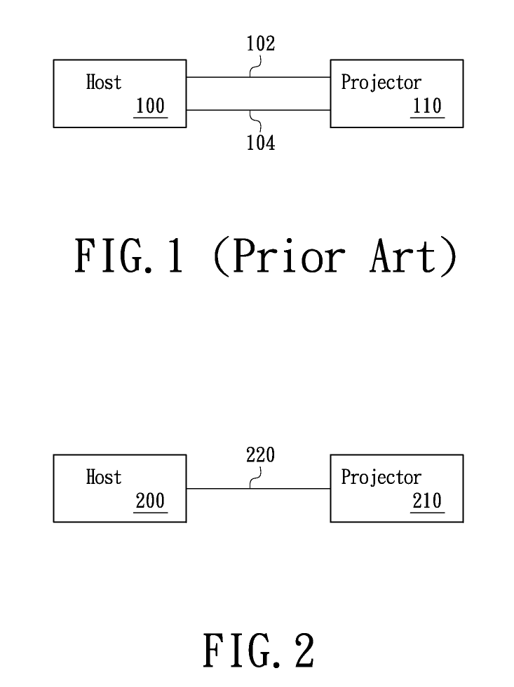

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Referring to FIG. 2, a projection system in accordance with an exemplary embodiment of the present invention is provided. In the exemplary embodiment, the projection system includes a host 200, a projector 210 and a signal line 220 configured for transmitting multimedia data. The host 200 employs the multimedia data transmitted to the projector 210 through the signal line 220 to adjust or control the projector 210. In the exemplary embodiment, the multimedia data transmitted to the projector 210 includes some predetermined data embedded therein such that the projector 210 is controlled properly by the multimedia data. If the projector 210 detects that the received multimedia data includes the predetermined data, the projector 210 may auto-start the adjusting/controlling mechanisms, and adjust the intrinsic parameters thereof or perform the corresponding controlling operation according to the received predetermined data.

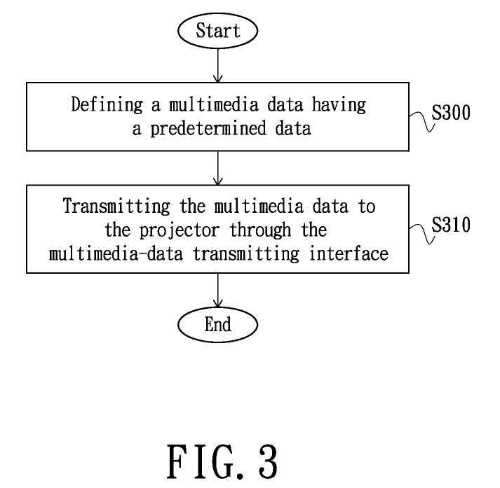

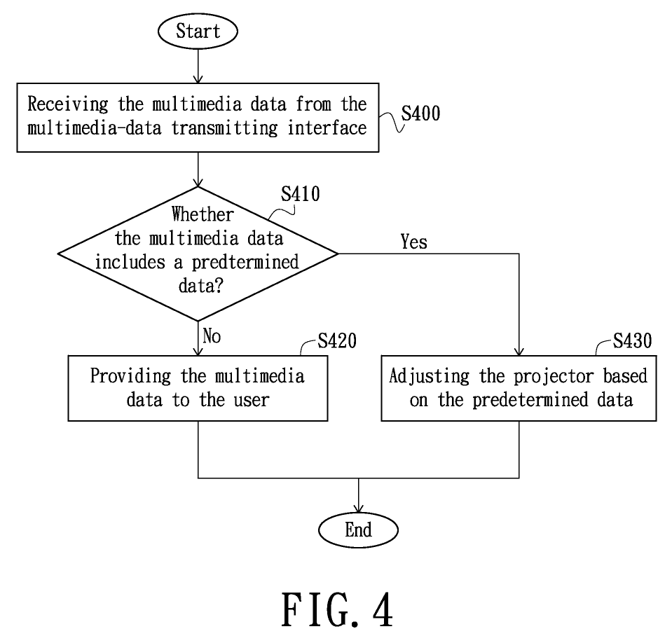

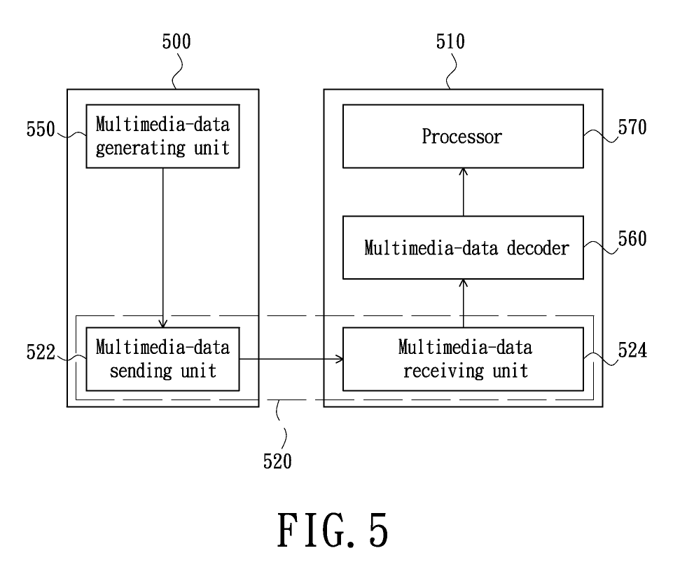

The following describes this exemplary embodiment in detailed according to FIGS. 3-5. FIG. 3 and FIG. 4 are flow charts of a method for controlling projector in accordance with an exemplary embodiment of the present invention, respectively. FIG. 5 is a circuit block diagram of a projection system in accordance with an exemplary embodiment of the present invention.

Referring to FIG. 5, the projection system of the exemplary embodiment includes a host 500 and a projector 510. The host 500 includes a multimedia-data generating unit 550 and a multimedia-data sending unit 522, and the projector 510 includes a multimedia-data receiving unit 524, a multimedia-data decoder 560, and a processor 570. In addition, the multimedia-data sending unit 522 and the multimedia-data receiving unit 524 composes a multimedia-data transmitting interface 520 configured for transmitting the multimedia data between the host 500 and the projector 510.

Referring to FIGS. 3 and 5, the operation of the host 500 is provided. If the host 500 is used to control or adjust the projector 510, a predetermined data is defined and then is embedded into a multimedia data by the multimedia-data generating unit 550 (step S300). Furthermore, the predetermined data may be defined by the multimedia-data generating unit 550 similarly, or be defined by other hardware or software of the host 500. After the multimedia data including the predetermined data is generated, the multimedia data is sent out to the projector 510 through the multimedia-data sending unit 522 of the multimedia-data transmitting interface 520 (step S310), such that the projector 510 may receive the multimedia data and adjust the various parameters or perform the various controlling operation according to the multimedia data.

Referring to FIGS. 4 and 5, the operation of the projector 510 is provided. The projector 510 has a memory (may be a built-in memory or any portable memory) therein to store the predetermined data, or employs a particular method to lock the predetermined data. However, at all events, the multimedia data is transmitted to the multimedia-data decoder 560 in advance after the projector 510 receives the multimedia data through the multimedia-data receiving unit 524 of the multimedia-data transmitting interface 520 (step S400). After the multimedia-data decoder 560 decodes the received multimedia data to obtain a decoded result, the decoded result may be transmitted to the processor 570. The processor 570 judges whether the decoded multimedia data includes the predetermined data, and determines methods for processing the multimedia data (step S410). If the multimedia data does not include the predetermined data, the multimedia data is determined as a normal multimedia data (such as displayed images, or played sounds) and is provided to the users (step S420). Contrarily, if the multimedia data includes the predetermined data, the multimedia data is determined as a group of control signals, and the processor 570 may adjust the parameters of the projector or control the various operation of the projector according to the predetermined data from the decoded multimedia data (step S430).

For example, the user may employ image-editing software or related programs to edit an image, and the head of the image has the predetermined data defined by a group of a plurality of particular values arranged in a particular sequence. For example, the first five bits of the image are set to be 127, 128, 129, 130, and 131 respectively. The image with the particular sequence may be served as the multimedia data transmitted from the host 500 to the projector 510. Correspondingly, if the projector 510 receives, decodes, and determines the first five bits of the image to be 127, 128, 129, 130, and 131, the following data bits are served as the control command. For example, if the five bits are 127, 128, 129, 130, and 131 respectively, the processor 570 determines the object of the control command according to the sixth bit. The object of the control command may be updating of the program code, alteration of the commands in the memory, or changing of the parameters. The several following bits are served as the data of the control command, such as the address and the content of the updated program code, new commands of the memory, or parameters.

According to the embodiments mentioned above, the user may create an image, and the first five bits of the image are 127, 128, 129, 130, and 131 to represent that the image is used to control the projector. The sixth bit is defined as 0 to represent adjusting the brightness of the projector, the seventh to ninth bits are all defined as 128, and the tenth to fifteenth bits are defined as 0, 0, 0, 0, 5, and 0 respectively, to define the value of the adjusted brightness to be 50. If the projector receives the image, the projector compares the image with the predetermined data stored in the projector to adjust or control the projector correspondingly.

Noticeably, although the above exemplary embodiment employs the image as the multimedia data, the present invention may employ other multimedia data, such as sound. The other mode is similar to the above exemplary embodiments. For example, if the decoded multimedia data is image data, the multimedia-data decoder 560 needs to include an image-data decoder. However, if the decoded multimedia data is sound data, the multimedia-data decoder 560 needs to include a sound-data decoder. Furthermore, the processor 570 may be an application specified integrated circuit (ASIC) or other programmable circuits.

From the above, the exemplary embodiment of the present invention employs the multimedia data including the predetermined data as the control signal, such that the exemplary embodiment may employ the multimedia-data transmitting interface or the related transmitting line to display the images and control the projector. Furthermore, the exemplary embodiment does not need the independent transmitting interface configured for transmitting the control commands, such that the manufacturing cost thereof is decreased and the operation thereof is simpler.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for controlling projector, the method being adapted to a projector, the projector is capable of receiving a multimedia data from a host and through a multimedia-data transmitting interface, and the method comprising:
judging whether the multimedia data comprises a predetermined data; and
performing an operation for controlling the projector corresponding to the predetermined data if the multimedia data comprises the predetermined data.

2. The method as claimed in claim 1, wherein the multimedia data comprises an image data.

3. The method as claimed in claim 1, wherein the multimedia data comprises a sound data.

4. The method as claimed in claim 1, wherein the predetermined data comprises a precedence code, a classification code, and an operation code.

5. The method as claimed in claim 4, wherein the precedence code comprises a plurality of particular values arranged in a particular sequence.

6. A method for controlling projector, the method being adapted to a host, the host being electrically connected to a projector through a multimedia-data transmitting interface, the method comprising:
producing a multimedia data comprising a predetermined data; and
transmitting the multimedia data to the projector through the multimedia-data transmitting interface to control the projector.

7. The method as claimed in claim 6, wherein the multimedia data comprises an image data.

8. The method as claimed in claim 6, wherein the multimedia data comprises a sound data.

9. The method as claimed in claim 6, wherein the predetermined data comprises a precedence code, a classification code, and an operation code.

10. The method as claimed in claim 9, wherein the precedence code comprises a plurality of particular values arranged in a particular sequence.

11. A projection system, comprising:
a host, comprising:
a multimedia-data generating unit configured for providing a multimedia data; and
a multimedia-data sending unit electrically connected to the multimedia-data generating unit and configured for receiving the multimedia data and transmitting the multimedia data out of the host; and
a projector, comprising:
a multimedia-data receiving unit electrically connected to the multimedia-data sending unit of the host and configured for receiving the multimedia data from the multimedia-data sending unit;
a multimedia-data decoder electrically connected to the multimedia-data receiving unit and configured for decoding the multimedia data from the multimedia-data receiving unit to obtain a decoded result; and
a processor configured for controlling the projector according to the predetermined data if the decoded result represents the multimedia data comprising the predetermined data.

12. The projection system as claimed in claim 11, wherein the processor is an application specified integrated circuit.

13. The projection system as claimed in claim 11, wherein the multimedia-data decoder comprises an image-data decoder configured for decoding an image data of the multimedia data.

14. The projection system as claimed in claim 11, wherein the multimedia-data decoder comprises a sound-data decoder configured for decoding a sound data of the multimedia data.
